(19) United States
(12) Patent Application Publication
(10) Pub. No.: US 2007/0035251 A1
(43) Pub. Date: Feb. 15, 2007

(54) Cold cathode fluorescent lamp and electrode thereof

(75) Inventors: Ruey-Feng Jean, Taoyuan Hsien (TW); Kuang-Lung Tsai, Taoyuan Hsien (TW); Maw-Chuan Lin, Taoyuan Hsien (TW); Shih-Hsien Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/493,700

(22) Filed: Jul. 27, 2006

(30) Foreign Application Priority Data
Aug. 12, 2005 (TW) 094127415

(51) Int. Cl. H01J 17/04

(52) U.S. Cl. 313/633; 313/346 R

(57) ABSTRACT

An electrode for a cold cathode fluorescent lamp includes a leading wire and an electron emissive layer, which is formed by spirally and tightly winding a first electrically conductive material. One end of the first electrically conductive material is connected to the leading wire. The electrode has advantages of low cost and ease for manufacture.

### BACKGROUND OF THE INVENTION

1. Field of Invention

The present invention relates to an electrode, and more particularly to an electrode for a cold cathode fluorescent lamp.

2. Related Art

Non self-emitting displays, such as liquid crystal displays (LCD), require a backlight module disposed at the back of the LCD to provide a light source. Currently, a cold cathode fluorescent lamp (CCFL) is generally used as the light source of the backlight module.

As shown in FIG. 1, a conventional CCFL 10 is an air-tight glass tube 101 filled with inert gas and mercury vapor therein. The inner wall of the glass tube 101 is coated with a fluorescent layer 102. Both ends of the glass tube 101 are sealed with a pair of electrodes 103. The electrodes 103 outside the glass tube are connected to a high-voltage source via a leading wire 11. When the high-voltage source drives the electrodes 103 to discharge, the energized electrons collide with the mercury vapor and the inert gas to radiate ultraviolet (UV) light. Then, the LV light excites the fluorescent layer 102 on the glass tube 101 to generate visible light. The electrode 103 is in a hollow cylinder shape (as shown in FIG. 1), and nickel (Ni) is usually used as the material of the electrode 103 due to its low cost and ease for stamping.

In view of the versatility of LCD, the CCFL 10 tends to be compact in size and diameter, higher brightness and longer lifetime. To gain higher brightness, the voltage is often increased. However, the large power consumption shortens the lifetime of the CCFL 10. On the other hand, during the discharging process, the electrodes 103 are bombarded by ions, and its material will be sputtered onto the inner wall of the glass tube 101, and react with the mercury vapor. There will be a lot of mercury vapor consumed in the glass tube 101. At the same time, the electrodes 103 also become thinner due to corrosion. Therefore, the lifetime of the CCFL 10 is inevitably shortened.

In order to solve the above-mentioned problem, the materials, such as molybdenum (Mo) and niobium (Nb) with work functions relatively lower than that of nickel, are proposed to make the electrodes 103; they have a lower threshold voltage, a better resistance for ion impacts, and are hard to react with the mercury vapor. Thus, the lifetime of the CCFL 10 is prolonged. However, the extensibilities of Mo and Nb are not as good as Ni and have difficulty in stamping for the hollow cylinder structure. Thus, the cost of manufacturing the electrodes 103 by stamping inevitably increases with these materials with lower work functions.

### SUMMARY OF THE INVENTION

In view of the foregoing, the present invention provides a long lifetime electrode, made of materials with low extensibility, for a CCFL.

To achieve the above, an electrode for a CCFL according to the present invention includes a leading wire and an electron emissive layer. The electron emissive layer is formed by spirally and tightly winding a first electrically conductive material. One end of the first electrically conductive material is connected to the leading wire.

To achieve the above, a CCFL according to the present invention includes a sealed body and at least one electrode. The electrode is disposed at one end of the sealed body. The electrode includes an electron emissive layer formed by spirally and tightly winding a first electrically conductive material. One end of the first electrically conductive material is connected to a leading wire.

As mentioned above, a CCFL according to the present invention utilizes a spirally and tightly wound electrically conductive material to form a electrode, which avoids the stamping process of making a hollowly cylindrical structure. Thus, the electrode of the present invention can be made of electrically conductive material with low extensibility, high rigidity and high brittleness. Comparing with the prior art, the present invention reduces the difficulty in and cost of manufacturing an electrode of a CCFL by using low extensibility and low work function material. Further, the present invention also can prolong the lifetime of the CCFL and raise the yield.

### BRIEF DESCRIPTION OF THE DRAWINGS

The present invention will become more fully understood from the detailed description given herein below illustration only, and thus are not limitative of the present invention, and wherein:

FIG. 1 is a schematic view of a conventional CCFL;

FIG. 2 is a schematic view of a CCFL according to an embodiment of the present invention; and

FIGS. 3 to 7 are schematic views showing various embodiments of electrodes for the CCFL according to the present invention.

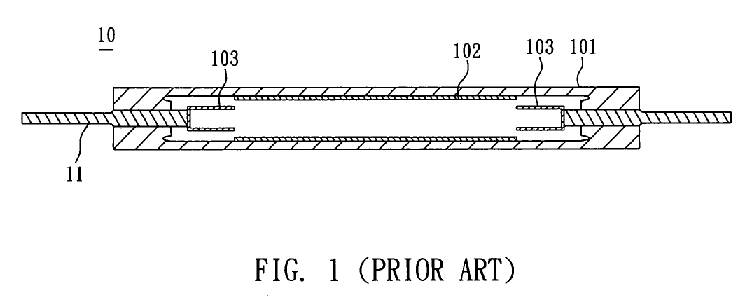

### DETAILED DESCRIPTION OF THE INVENTION

The present invention will be apparent from the following detailed description, which proceeds with reference to the accompanying drawings, wherein the same references relate to the same elements.

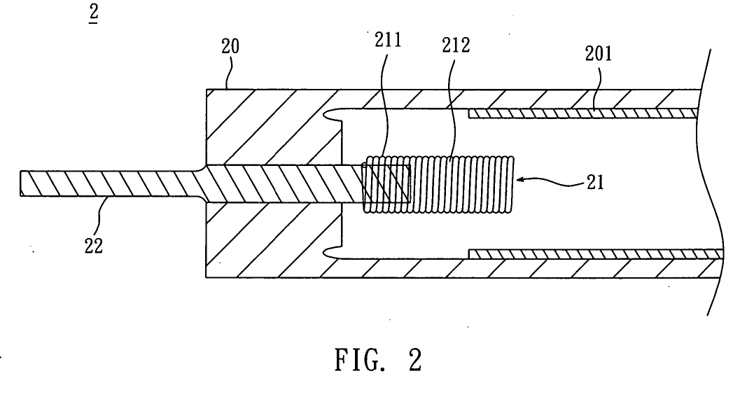

With reference to FIG. 2, a CCFL 2 according to an embodiment of the present invention includes a sealed body 20 and at least one electrode 21.

The inner surface of the sealed body 20 is coated with a fluorescent layer 201. The inside of the sealed body 20 is filled with inert gas and mercury vapor.

The electrode 21 is disposed at one end of the sealed body 20 and includes an electron emissive layer 211 for emitting electrons. The electron emissive layer 211 is formed by spirally and tightly winding a first electrically conductive material 212. The first electrically conductive material 212 is one selected from the group consisting of BaO, CaO, SrO, Ni, Ti, Nb, Mo and their alloys.

In this embodiment, the first electrically conductive material 212 is a wire with a circular, elliptical, polygonal or irregular cross-section. The electron emissive layer 211 is in the shape of a hollow cylinder formed by spirally and tightly winding the wire. Of course, the hollowly cylindrical structure mentioned herein is only an example and should not be used to restrict the scope of the present invention. The electron emissive layer 211 in any other shapes can also be used to make the electrode 21.

One end of the first electrically conductive material 212 is connected to a leading wire 22, which is connected with a driving power source (not shown). The driving power source provides energy for the electrode 21 to emit electrons. The energized electrons collide with the inert gas and the mercury vapor to radiate UV light. Then, the UV light excites the fluorescent layer 201 to generate visible light.

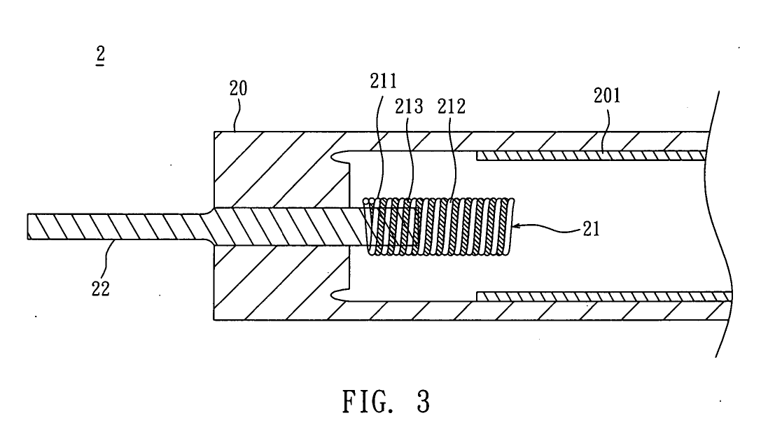

With reference to FIG. 3, in order to enhance the structural strength of the electrode 21, the electron emissive layer 211 of the CCFL 2 further includes a second electrically conductive material 213. The second electrically conductive material 213 is wound spirally and alternately with the first electrically conductive material 212 to form the electron emissive layer 211. The second electrically conductive material 213 is one selected from the group consisting of BaO, CaO, SrO, Ni, Ti, Nb, Mo and their alloys. The material of the second electrically conductive material 213 can be the same as or different from that of the first electrically conductive material 212, as long as they can combine tightly to form the electrode 21.

In order to enhance the structural strength of the electrode 21, the second electrically conductive material 213 can also be wound with the first electrically conductive material 212 to be a two-layer structure for the electrode (not shown). As described above, the material of the second electrically conductive material 213 can be the same as or different from that of the first electrically conductive material 212.

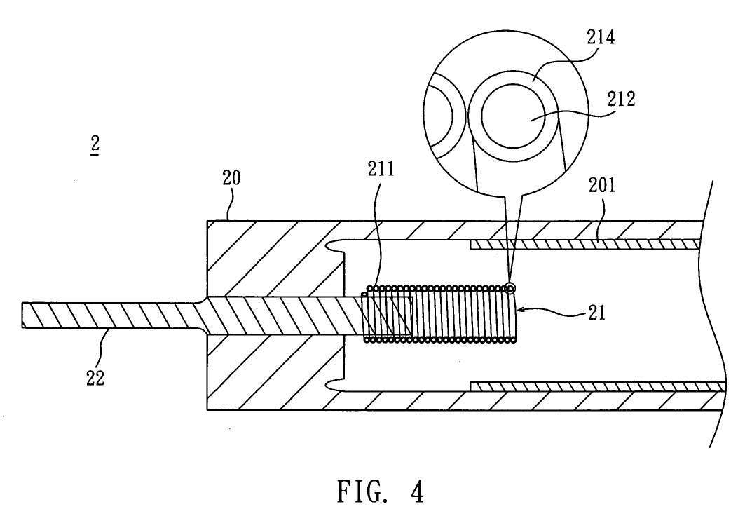

With reference to FIG. 4, the electron emissive layer 211 of the CCFL 2 further includes a third electrically conductive material 214 covering the first electrically conductive material 212. The work function of the third electrically conductive material 214 is relatively lower than that of the first electrically conductive material 212. In this embodiment, the third electrically conductive material 214 is one selected from the group consisting of BaO, CaO, SrO, Ni, Ti, Nb, Mo and their alloys. With this structure, the electron emissive layer 211 has a lower threshold voltage. Moreover, the manufacturing cost of the electrode 21 can also be effectively reduced.

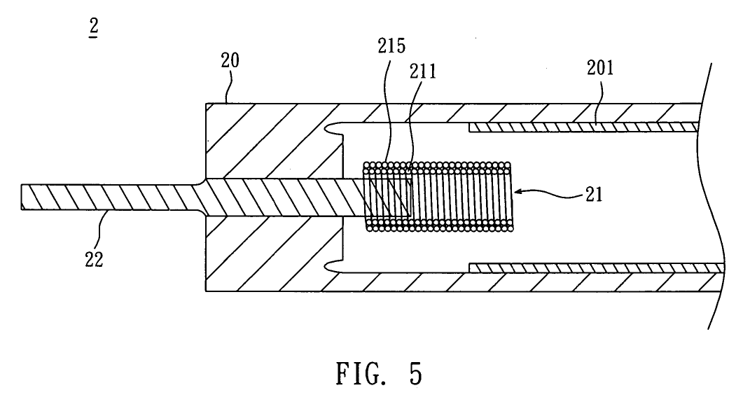

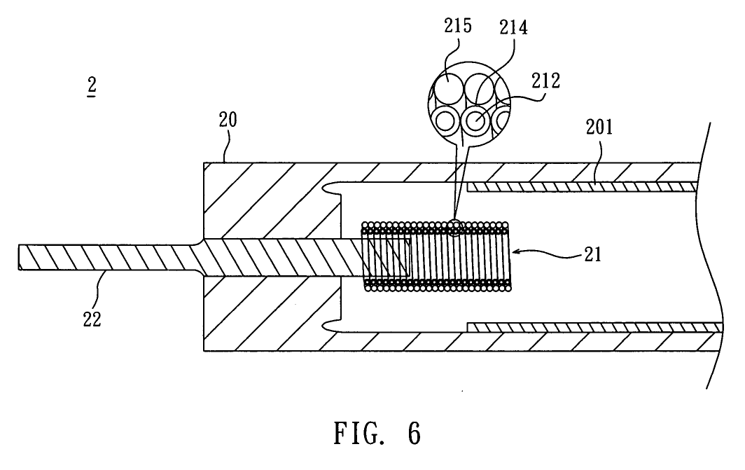

With reference to FIG. 5, the electrode 21 of the CCFL 2 further includes an impact resistant layer 215 formed by spirally winding an impact resistant material. The impact resistant layer 215 covers at least a portion of the outer surface of the electron emissive layer 211. That is, the impact resistant layer 215 can cover the entire or a portion of the electron emissive layer 211. The impact resistant material of the impact resistant layer 215 is one selected from the group consisting of ceramics, Ti, Nb, Mo and their alloys, to protect the electron emissive layer 211 from ion impacts. The above-mentioned materials are just examples; any other materials resistant to ion impacts can be used as well. With reference to FIG. 6, the impact resistant layer 215 can also cover the electron emissive layer 211 of FIG. 4. The impact resistant layer 215 can protect the third electrically conductive material 214 from being bombarded by ions and sputtered onto the inner wall of the sealed body 20, and thus prevent over-consumption of the mercury vapor.

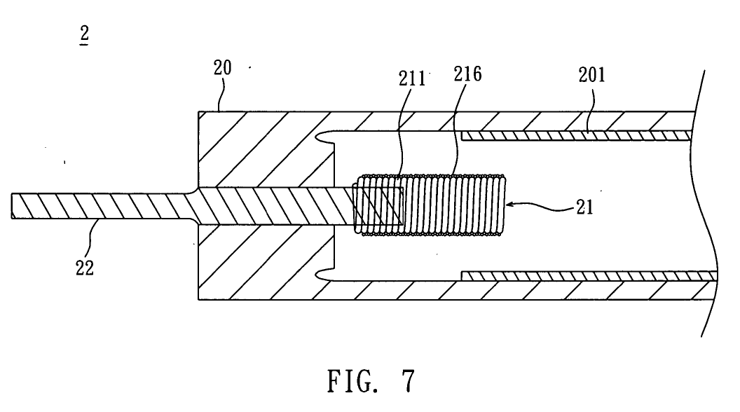

With reference to FIG. 7, the electrode 21 of the CCFL 2 further includes an insulating layer 216 covering at least a portion of the outer surface of the electron emissive layer 211. That is, the insulating layer 216 can cover the entire or a portion of the electron emissive layer 211. The material of the insulating layer 216 is, for example Al₂O₃, to prevent the material of the electron emissive layer 211 from being bombarded and sputtered onto the inner wall of the sealed body 20.

In summary, a CCFL and an electrode thereof according to the present invention utilize an electrically conductive material spirally and tightly winding to form the electrode. Because of the spiral winding structure of the electrode, the present invention can avoid the stamping process of making a hollowly cylindrical electrode of the prior art. Therefore, the present invention is more suitable for electrically conductive materials with low extensibility, high rigidity and high brittleness. Comparing with the prior art, the present invention reduces the difficulty in and cost of using materials with low extensibility and work function to make the electrode. The present invention also can prolong the lifetime of the CCFL and raise the product yield.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An electrode for a cold cathode fluorescent lamp (CCFL), comprising:
a leading wire; and
an electron emissive layer formed by spirally winding a first electrically conductive material, wherein one end of the first electrically conductive material is connected to the leading wire.

2. The electrode according to claim 1, wherein the first electrically conductive material is one selected from the group consisting of BaO, CaO, SrO, Ni, Ti, Nb, Mo and their alloys.

3. The electrode according to claim 1, wherein the electron emissive layer further comprises a second electrically conductive material spirally and alternately wound with the first electrically conductive material, or wound with the first electrically conductive material to be a two-layer structure.

4. The electrode according to claim 3, wherein the second electrically conductive material is one selected from the group consisting of BaO, CaO, SrO, Ni, Ti, Nb, Mo and their alloys.

5. The electrode according to claim 1, wherein the electron emissive layer further comprises a third electrically conductive material with a work function relatively lower than that of the first electrically conductive material to cover the first electrically conductive material.

6. The electrode according to claim 5, wherein the third electrically conductive material is one selected from the group consisting of BaO, CaO, SrO, Ni, Ti, Nb, Mo and their alloys.

7. The electrode according to claim 1, further comprising an impact resistant layer formed by spirally winding an impact resistant material to cover a portion of the outer surface of the electron emissive layer.

8. The electrode according to claim 7, wherein the impact resistant material is one selected from the group consisting of ceramics, Ti, Nb, Mo and their alloys.

9. The electrode according to claim 1, further comprising an insulating layer covering a portion of the outer surface of the electron emissive layer.

10. The electrode according to claim 9, wherein the material of the insulating layer is Al₂O₃.

11. A cold cathode fluorescent lamp (CCFL), comprising:
a sealed body; and
at least one electrode disposed at one end of the sealed body and comprising an electron emissive layer formed by spirally winding a first electrically conductive material, wherein one end of the first electrically conductive material is connected to a leading wire.

12. The CCFL according to claim 11, wherein the first electrically conductive material is one selected from the group consisting of BaO, CaO, SrO, Ni, Ti, Nb, Mo and their alloys.

13. The CCFL according to claim 11, wherein the electron emissive layer further comprises a second electrically conductive material spirally and alternately wound with the first electrically conductive material, or wound with the first electrically conductive material to be a two-layer structure.

14. The CCFL according to claim 13, wherein the second electrically conductive material is one selected from the group consisting of BaO, CaO, SrO, Ni, Ti, Nb, Mo and their alloys.

15. The CCFL according to claim 11, wherein the electron emissive layer further comprises a third electrically conductive material with a work function relatively lower than that of the first electrically conductive material to cover the first electrically conductive material.

16. The CCFL according to claim 15, wherein the third electrically conductive material is one selected from the group consisting of BaO, CaO, SrO, Ni, Ti, Nb, Mo and their alloys.

17. The CCFL according to claim 11, further comprising an impact resistant layer formed by spirally winding an impact resistant material to cover a portion of the outer surface of the electron emissive layer.

18. The CCFL according to claim 17, wherein the impact resistant material is one selected from the group consisting of ceramics, Ti, Nb, Mo and their alloys.

19. The CCFL according to claim 11, further comprising an insulating layer covering a portion of the outer surface of the electron emissive layer.

20. The CCFL according to claim 19, wherein the material of the insulating layer is Al₂O₃.
